(19) United States
(12) Patent Application Publication
(10) Pub. No.: US 2008/0173700 A1
(43) Pub. Date: Jul. 24, 2008

(54) SYSTEM AND METHOD FOR SOLDER BONDING

(76) Inventor: MEHLIN DEAN MATTHEWS, SARATOGA, CA (US)

Correspondence Address: MEHLIN DEAN MATTHEWS, P.O. BOX 24, SARATOGA, CA, 95071, US

(21) Appl. No.: 11/625,345

(22) Filed: Jan. 22, 2007

(51) Int. Cl. B23K 31/02; B23K 35/34; B23K 3/00

(52) U.S. Cl. 228/249; 228/57; 148/23

(57) ABSTRACT

A volatile soldering aid for solder bonding surfaces. A thermally decomposable solid that is suspended in a carrier or dissolved in a solvent is incorporated in a solder assembly having two surfaces separated by a solder preform. The solvent or carrier is subsequently evaporated, and the assembly is heated to decompose the solid and produce a reducing gas. The assembly is then further heated to melt the solder preform. A vacuum may be introduced to remove the gas prior to melting of the solder preform. The solder preform in the assembly may be a monolithic preform or it may be a powder. The solder preform may be provided as a thin film deposited on one or both of the surfaces to be joined. Upon heating, the volatile soldering aid is converted to vapor without forming a liquid phase at the melting point of the solder.

### BACKGROUND OF THE INVENTION

1. Field of the Invention

This invention relates to the bonding of electronic components using a solder. In particular, the invention relates to die attach of semiconductors using gold/tin solder.

2. Description of Related Art

Electrical components are frequently bonded using solders. Solders may be used as a monolithic preform, or as a powder combined with a flux and applied as a paste. A neutral or reducing gas may also be provided to inhibit oxidation. A solder alloy is distinguished from a braze alloy in that it has a melting point below 427° C.

Fluxes are effective in removing oxides; however, they generally do so by dissolving the oxides in a liquid phase that is present at the melting point of the solder with which they are used. Upon cooling to room temperature, a solid residue is formed, and depending upon the nature of the flux, removal may or may not be required. Removal is typically recommended for fluxes containing halides such as ammonium chloride or zinc chloride.

Conventional gas atmospheres (e.g., nitrogen/hydrogen) may be useful for excluding oxidizing agents and avoiding residues, but they are of limited efficacy in reducing or removing native oxides on the surface of solder preforms and powders. For example, when a die attach is performed under a conventional gas blanket, a mechanical “scrubbing” of the die may be required to displace oxides and improve the wetting of the surfaces being bonded.

Solder pastes containing fluxes may be used to provide enhanced solder flow characteristics, but they generally have a significant volume of residue that must be removed after the attach is complete. The residue may also impede solder flow and contribute to voids when large surface areas are being bonded, particularly if the bonding time is short and the viscosity of the residue at the bonding temperature is high.

Thus, there is a need for a system and method for soldering that provides an improved capacity for reduction of native oxides, while minimizing the impact of residues on solder flow.

### BRIEF SUMMARY OF THE INVENTION

Accordingly, a system for solder bonding surfaces with a locally generated reducing gas mixture is described herein. A volatile soldering aid including a thermally decomposable solid is incorporated in an assembly that includes a solder preform and the surfaces to be bonded. The solid is decomposed at a temperature below the melting point of the solder to provide a reducing gas atmosphere prior to melting of the solder.

In an embodiment of the present invention, a solution containing a thermally decomposable solid is dissolved in a solvent and applied to two surfaces separated by a solder preform. The separation between the surfaces is small enough to allow capillary forces to draw the solution into the gap on either side of the preform and the adjacent surface. The solvent is subsequently evaporated, and the assembly is heated to decompose the solid and produce a reducing gas. The assembly is then further heated to melt the solder preform. A vacuum may be introduced to remove the gas prior to melting of the solder preform.

In another embodiment, a powder of a thermally decomposable solid is suspended in a hydrophobic liquid that has a boiling point below or near the melting point of the solder to provide a paste that may be applied to an assembly for soldering. The solder preform in the assembly may be a monolithic preform or it may be a powder that is also suspended in the hydrophobic liquid. In a further embodiment, the solder preform may be provided as a thin film deposited on one or both of the surfaces to be joined.

### BRIEF DESCRIPTION OF THE DRAWINGS

FIG. 1A shows a solder assembly with a monolithic preform and decomposable solid/solvent solution in accordance with an embodiment of the present invention.

FIG. 1B shows the solder assembly of FIG. 1A after evaporation of the solvent and prior to decomposable solid decomposition.

FIG. 1C shows the solder assembly of FIG. 1B after decomposable solid decomposition and solder flow.

FIG. 2A shows a solder assembly with a powder preform and decomposable solid/carrier suspension in accordance with an embodiment of the present invention.

FIG. 2B shows the assembly of FIG. 2A after evaporation of the carrier.

FIG. 3 shows a solder assembly with a surface coating preform and decomposable solid/carrier suspension in accordance with an embodiment of the present invention.

FIG. 4 shows a diagram for a soldering system in accordance with an embodiment of the present invention.

FIG. 5 shows a flow diagram for a soldering process in accordance with an embodiment of the present invention.

FIG. 6 shows a diagram for thermal and atmospheric profiles for a soldering process in accordance with an embodiment of the present invention.

### DETAILED DESCRIPTION OF THE INVENTION

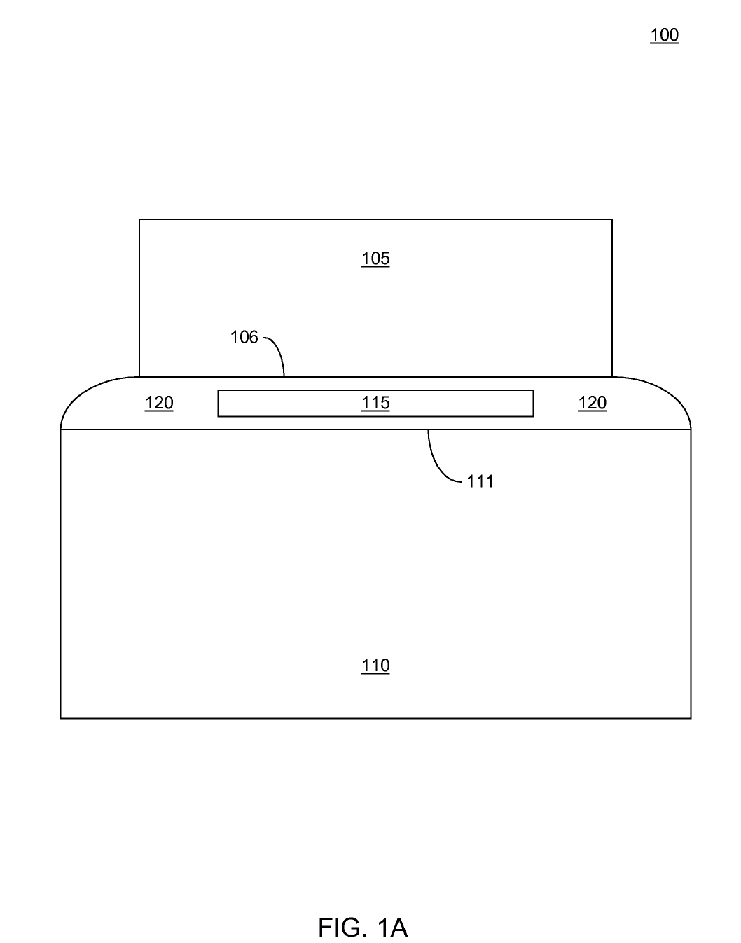

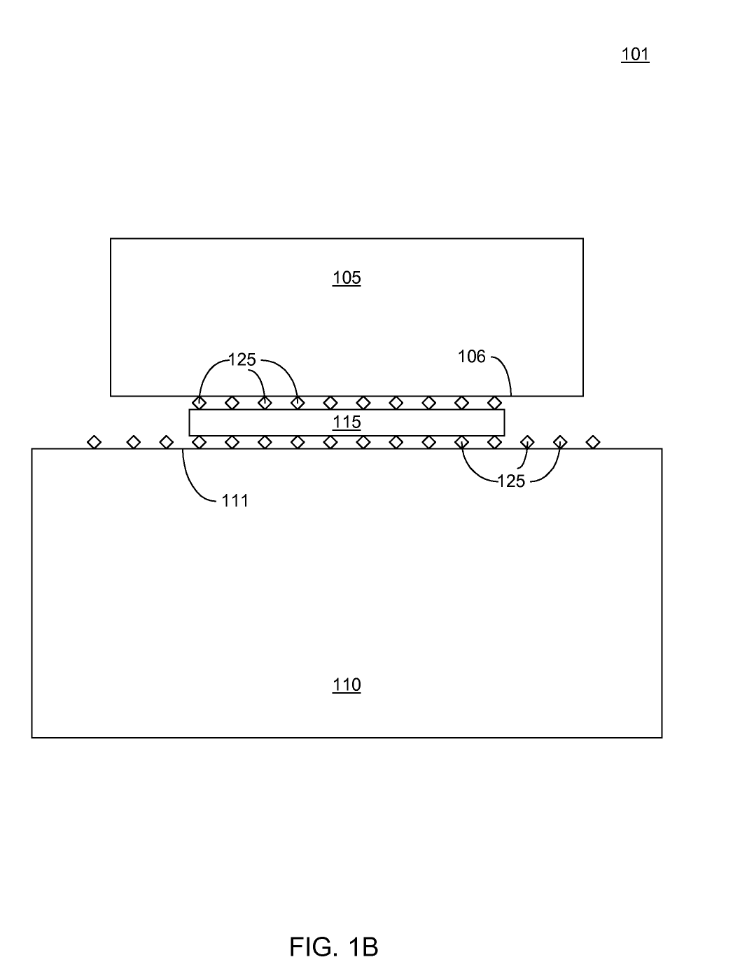

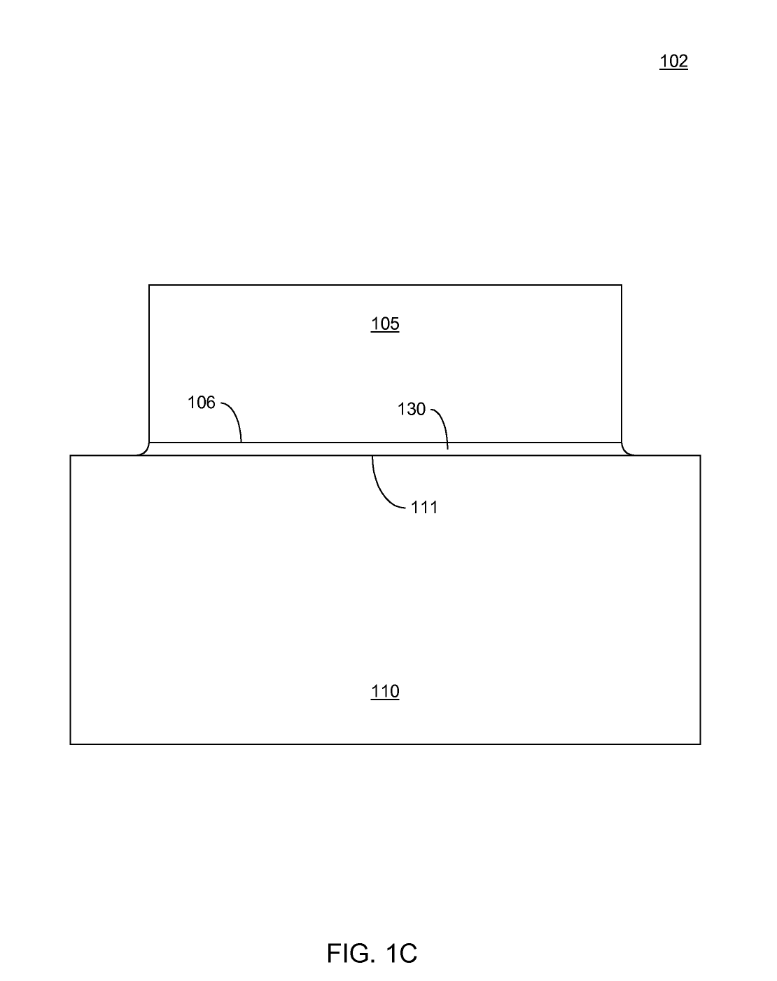

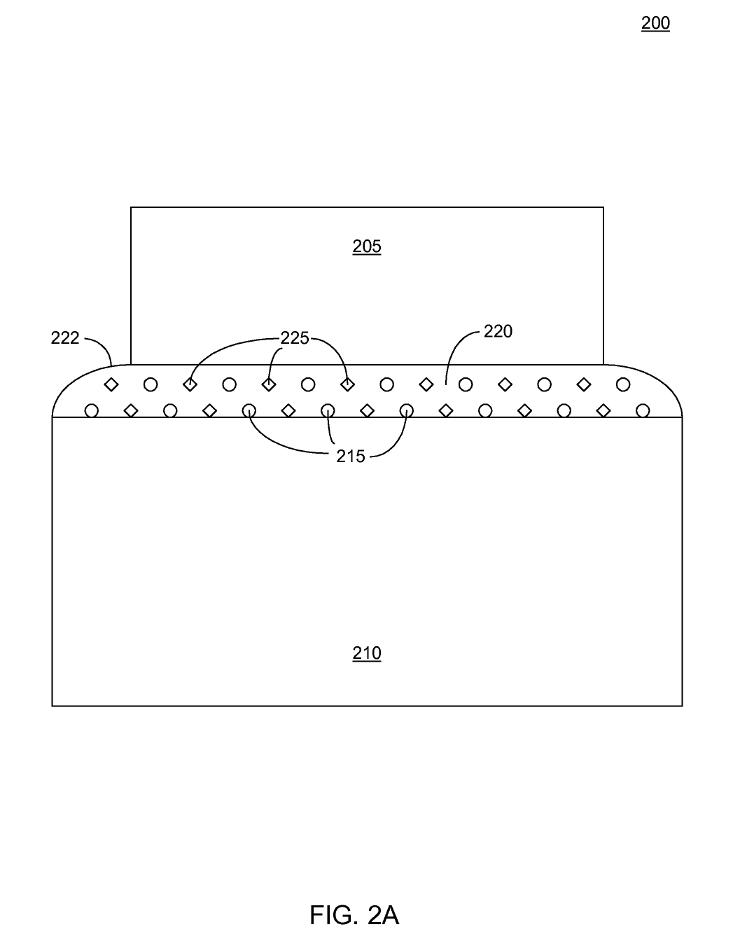

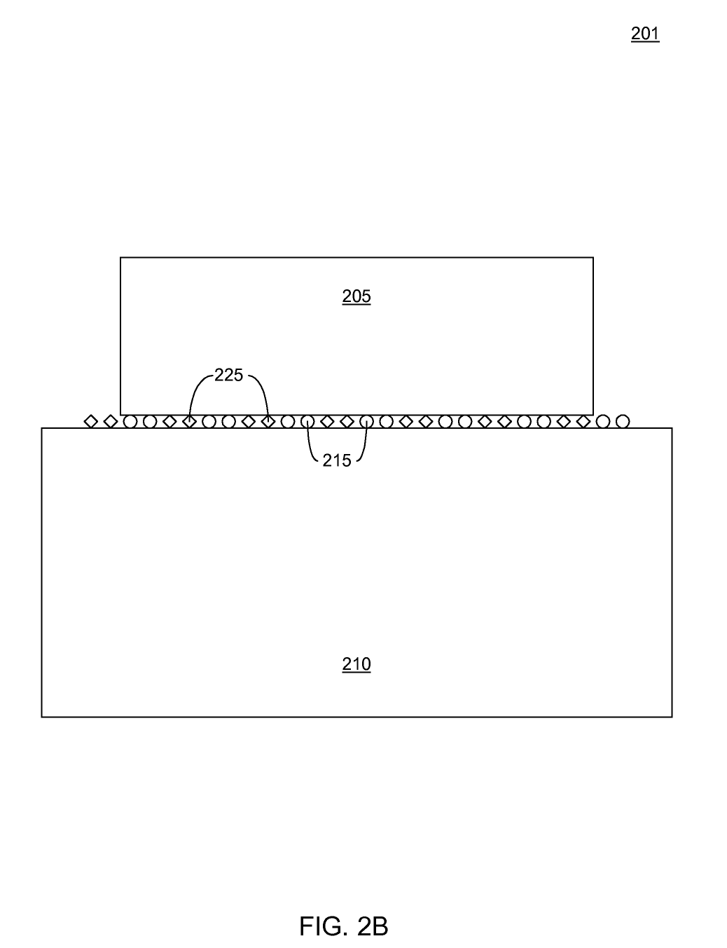

FIG. 1A shows an embodiment of a solder assembly 100 with a monolithic preform 115 and a volatile soldering aid 120 disposed between a semiconductor die 105 and a substrate 110. Soldering aid 120 is a decomposable solid 125 (shown in FIG. 2) dissolved in a liquid solvent. The semiconductor die has a bottom surface that is 106 that may be coated with gold or a gold alloy. The substrate 110 has a top surface 111 that may be coated with gold or a gold alloy. Surfaces 106 and 111 may also be coated with layer of a pure metal that is subsequently alloyed during the formation of a bond. In other embodiments, passive electronic components or mechanical structures may be substituted for the semiconductor die 105 and/or substrate 110.

For purposes of this disclosure, a “volatile soldering aid” is defined as a solution of, or a suspension of, a thermally decomposable solid in a liquid. The thermally decomposable solid is entirely converted to a vapor state when heated to the melting point of the solder with which it is being used. Conversion to a vapor phase is not dependent upon chemical reaction with other species (e.g., atmospheric oxygen). The soldering aid as a whole is converted entirely to vapor at the melting point of the solder. The liquid component is converted to vapor through evaporation or decomposition, and the solid component is converted to vapor through decomposition.

Volatile soldering aid 120 may be an ionic solid dissolved in a polar solvent. For example, ammonium chloride may be dissolved in methanol. In general, decomposable solid 125 is a compound that is thermally decomposable into a gas mixture that is capable of removing oxides associated with surfaces 106 and 101, and the monolithic preform 115. The monolithic preform 115 may be a gold/tin eutectic alloy with a melting point of about 283° C. The monolithic preform 115 may also be a gold/tin alloy with a composition that is different from the eutectic composition.

It should be noted that although ammonium chloride is commonly used as a component in soldering fluxes, it is typically combined with other materials that prevent it from being completely convertible to a vapor state. In the present invention, the thermally decomposable solid does not contribute to the formation of a liquid phase that is used to dissolve oxides.

FIG. 1B shows an embodiment of a dry solder assembly 101 that is obtained from the solder assembly 100 of FIG. 1A after evaporation of the solvent and prior to decomposition of the decomposable solid 125. The use of the volatile soldering aid 120 allows for introduction of a dissolved decomposable solid into small gaps after assembly of parts for soldering. The amount of decomposable solid 125 that is deposited may be controlled by the adjusting the concentration of the decomposable solid in the decomposable volatile soldering aid 120, and by controlling the amount of the volatile soldering aid 120 that is applied.

Heating of the dry solder assembly 101 may be done to produce in situ decomposition of the decomposable solid 125, thus producing a volume of reactive gas where it is most desired. The decomposition of ammonium chloride into ammonia and hydrogen chloride produces an expanding volume of gas that sweeps the gap between surfaces 106 and 111.

Decomposition of the decomposable solid 125 may be carried out at a pressure other than atmospheric pressure (e.g., vacuum) in order to modify the decomposition behavior over temperature. A vacuum may be introduced after solid decomposition in order to remove residual gas. The removal of residual gas allows the surface tension of the liquid solder to collapse potential voids to a very small size prior to solidification.

FIG. 1C shows an embodiment of a finished solder 102 assembly obtained from the solder assembly 101 of FIG. 1B after solid decomposition and solder flow. The solder joint 130 (e.g., gold/tin) provides a complete fill of the gap between the semiconductor die 105 and a substrate 110. A solvent wash may be performed after die attach to remove solid reduction reaction products, if present, and/or initial impurities that may have been present in the decomposable solid.

When the semiconductor die 105 and substrate 110 have gold metallized surfaces, a volatile soldering aid 120 consisting of methanol and ammonium chloride may be used with an 80/20 gold eutectic preform to achieve full wetting and a specular finish on the exposed surface of the cooled solder joint 130, without mechanical agitation of the semiconductor die 105.

FIG. 2A shows a solder assembly 200 with a powder preform 215, and a soldering aid 220 that includes a decomposable solid 225 suspended as a particulate in a volatile carrier 222. In preparing the assembly 200, a measured amount of the powder preform 215 and soldering aid 220 may be deposited on the surface of the substrate 210 prior to placing the semiconductor die 205. Alternatively, a monolithic preform or a surface coating preform may be used in conjunction with a suspension of the decomposable solid 225 in the carrier 220.

For hygroscopic solids (e.g., ammonium chloride), the use of a hydrophobic carrier reduces the absorption of moisture by the solid. For components that are sensitive to corrosion in an electrolyte solution, the use of a nonpolar liquid allows an ionic solid to be used in a liquid without forming an electrolyte solution. Thus, a material (e.g., ionic compound) that may normally be corrosive in the presence of moisture may be used as the decomposable solid 225. Organic compounds may be selected on the basis of viscosity and vapor pressure in order to provide an optimum combination of handling and evaporation behavior as the carrier 222.

The carrier 222 may include a mixture of different compounds with different vapor pressures. For example, a low vapor pressure liquid with a boiling point of less than 100° C. may be used to provide dilution and low viscosity, and a high vapor pressure liquid with a boiling point greater than 100° C. may be used to maintain coverage of the decomposable solid 225 so that water absorption is avoided. Carrier 222 may include aromatic, aliphatic, or alicyclic hydrocarbon compounds.

FIG. 2B shows an assembly 201 produced by evaporation of the carrier 220 shown in FIG. 2A. The gap between the semiconductor die 205 and the substrate 210 contains an intimate mixture of the decomposable solid 225 and the solder preform 215. Alternatively, a monolithic preform or a surface coating preform may be used. A surface coating may be an alloy, or a layered composite of two metals. For example, a first layer of tin may be overlaid with a second layer of gold.

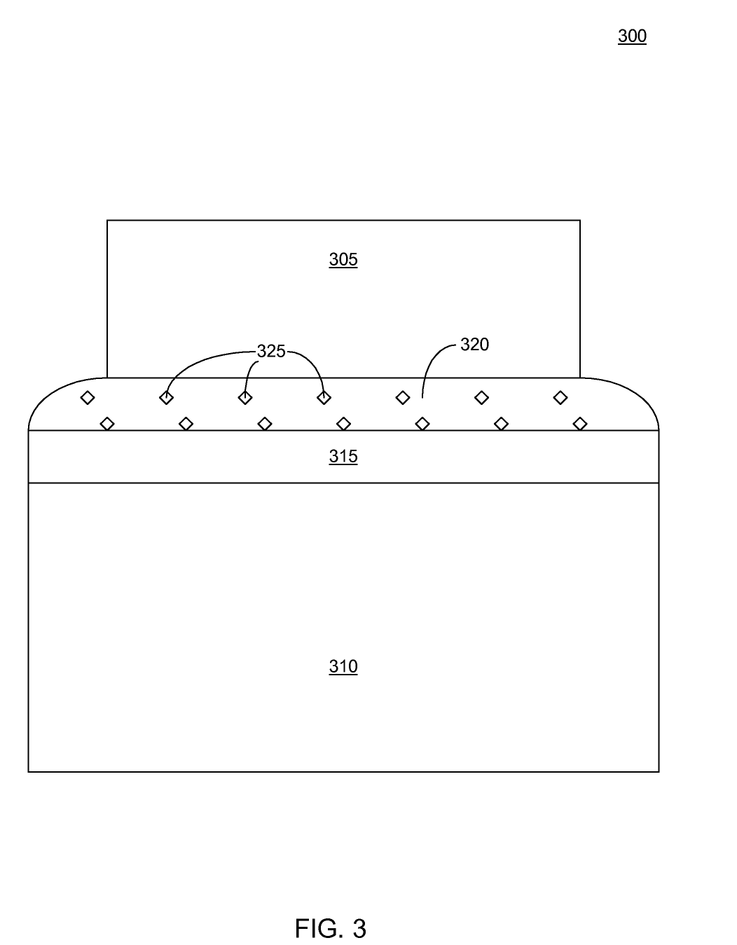

FIG. 3 shows a solder assembly 300 with a surface coating preform 315, and a decomposable solid 225 suspended in a carrier 320. The surface coating preform 315 is deposited on the surface of the substrate 310. however, the surface coating preform 315 may be deposited on the semiconductor die 305. The surface coating preform may be deposited as an alloy, or it may be deposited as distinct layers (e.g., gold over tin). Sputtering and electrodeposition may be used to deposit the surface coating preform 315.

A surface coating preform is particularly useful for flip-chip bonding of the semiconductor die 305. For example, the electrical contact pads of transistors are frequently closely spaced and thus vulnerable to bridging by excess solder. The use of a surface coating preform allows a small amount of solder to be precisely placed. When using a minimum amount of solder, it is important to avoid oxidation losses. Since the application of pressure and/or movement is not required during solder flow, soft columnar structures may be used at bonding sites on the semiconductor die 305 and substrate 310. A columnar structure may be used to provide a localized thermal capacitance for pulsed power applications, and may also be used to provide a buffer between a semiconductor die 305 and a substrate 310 that have different thermal expansion coefficients.

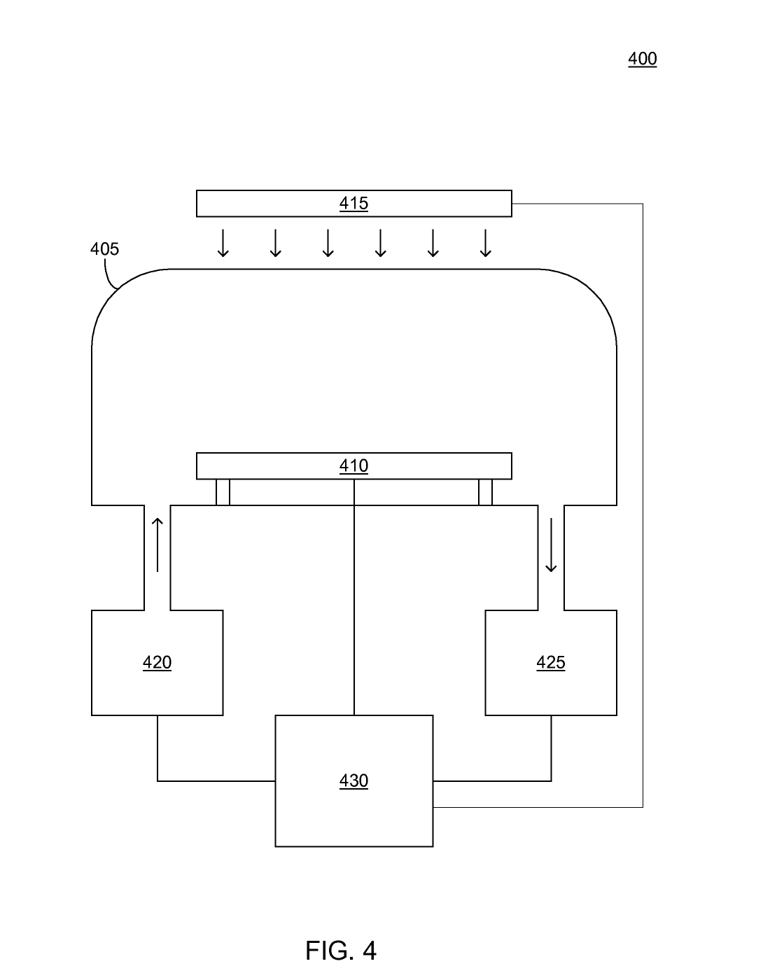

FIG. 4 depicts an embodiment of a soldering system 400 that may be used to provide a controlled atmosphere for soldering. A chamber 405 contains a stage 410 for supporting a solder assembly. The stage 410 may or may not be used as a heat source for soldering. A radiant heat source 415 may be used, particularly for heating under vacuum. A radiant heat source may be used in combination with a heated stage 410.

A gas source 420 may be used to provide a neutral atmosphere such as dry nitrogen. Depending upon the nature of the soldering process, the gas source may simply provide filtered air. The gas source 420 may be adapted to provide more than one gas composition, and may be used to pressurize the chamber 405 to a pressure greater than atmospheric pressure. A positive pressure may be used to purge the chamber 405, or to improve heat transfer across gaps in a solder assembly. A vacuum pump 425 may be used to exhaust the chamber 405 and provide a working pressure that is below atmospheric pressure.

Although a gas mixture (e.g., ammonia/hydrogen chloride) could be provided through the gas source 420 as an alternative to in situ decomposition of a solid, the local decomposition of a solid reduces the overall volume of gas required and provides a greater effective concentration of active species at the working surfaces. In order to achieve the same effective concentration, pre-evacuation and backfill at an overpressure would be required with a gas source. Another advantage of a solution or solid/liquid dispersion is that small components may be held in place so that gas flows or static charges will not easily displace them.

A controller 430 may be used to control the gas source 320, vacuum pump 425, radiant heater 415, and stage 410, if heated. The controller provides temperature and pressure profiles and controls the composition of the atmosphere within the chamber 405.

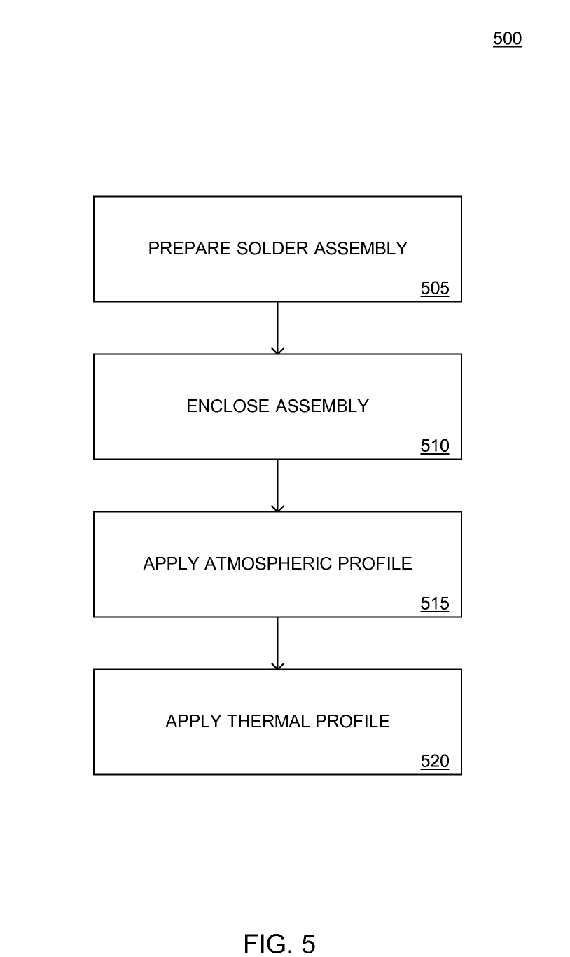

FIG. 5 shows a flow diagram 500 for an embodiment of a soldering process. In Step 505, a solder assembly is prepared. In general, a solder assembly includes two or more components to be soldered, with a decomposable solid and a solder preform disposed between the components. A volatile solvent or carrier may be used to dissolve or suspend the decomposable solid. The solder preform may be a powder, an individual piece of solder, or a coating on one or more of the components in the solder assembly.

In step 510, the solder assembly is enclosed. This may be done by placing the solder assembly in a chamber that provides for atmospheric and/or temperature control. Atmospheric control may include control of atmospheric composition and/or pressure. Temperature control may be provided by a heated stage that supports the solder assembly, or by radiant heating.

In step 515, an atmospheric profile is applied. The atmospheric profile may include segments for purging, pressurizing, and evacuating. Inert or reducing gases may be used for purging and pressurizing. Although satisfactory results have been obtained in air, it is generally desirable to have a vacuum, or an inert or reducing atmosphere in place during solid decomposition and solder flow.

In step 520, a thermal profile is applied. Although the thermal profile may be initiated prior to the application of the atmospheric profile, it is generally preferable to create an inert or reducing atmosphere prior to heating. Heat is applied to remove solvents and/or carriers. It is desirable to limit the heating rate so that dislocation of parts due to rapid vapor evolution during the evaporation and decomposition phases is avoided. A fixed temperature dwell below the decomposition temperature of the solid may be used to complete removal of the solvents and/or carriers. Subsequently, the assembly is heated to the solder flow temperature at a rate that allows for the complete decomposition of the solid prior to solder flow.

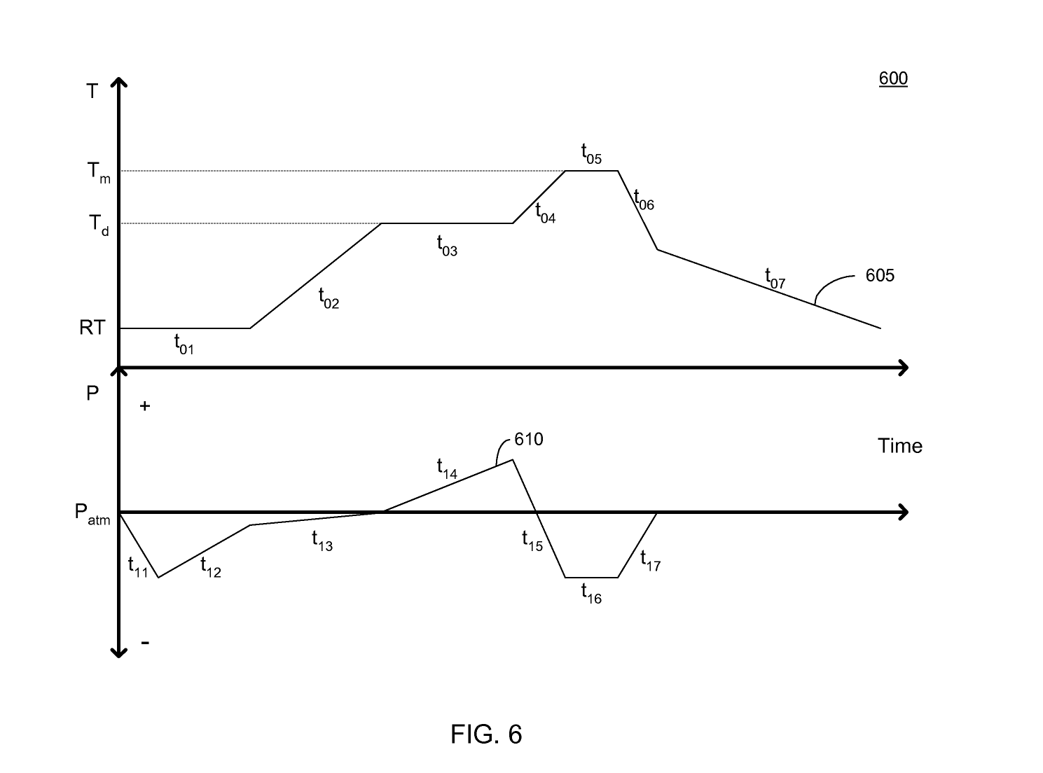

FIG. 6 shows a diagram 600 for embodiments of a thermal profile 605 and an atmospheric profile 610 that may be used in a soldering process with a volatile soldering aid. Several steps are shown for each profile, with various ramp segments and dwell segments that may or may not be present in other embodiments.

Thermal profile 605 is initiated at room temperature (RT) with a dwell time of t₀₁ that allows for a vacuum evacuation and partial backfill represented by pressure segments t₁₁ and t₁₂ of the atmospheric profile 610. Beginning at atmospheric pressure (Pₐₜₘ) air is evacuated during segment t₁₁, and an inert or reducing gas atmosphere (e.g., N₂ or N₂/H₂) is introduced in segment t₁₂.

During ramp segment t₀₂, heat is applied to the solder assembly to evaporate the liquid component of the soldering aid. Thermal ramp segment t₀₂ begins at room temperature and ends at a temperature T_{d} at which decomposition of the decomposable solid component of the soldering aid is achieved. During thermal ramp segment t₀₂, the pressure ramp segment t₁₃ shows a return to atmospheric pressure accompanying the evaporation. In general, pressure will be determined by the net mass flow into or out of the chamber, vapor evolution within the chamber, and temperature. Feedback-controlled valves or relief valves may be used to control pressure.

A thermal dwell segment t₀₃ occurs at T_{d} to allow for decomposition of the decomposable solid to a vapor. Due to the solid decomposition during the thermal dwell segment t₀₃, pressure rises above Pₐₜₘ during pressure segment t₁₄. Subsequently, the temperature is increased to the melting point of the solder (Tₘ) during thermal ramp segment t₀₄, while the pressure is reduced to a value below Patm as shown in pressure segment t₁₅.

A thermal dwell segment t₀₅ at Tₘ allows for melting of the solder, while the pressure dwell segment t₁₆ provides a low pressure to reduce trapped gas that would prevent collapse of voids in the molten solder. An initial cooling ramp t₀₆ provides for solidification of the solder and pressure segment t₁₇ provides a return to room temperature. the chamber may be purged at Pₐₜₘ to assist in cooling during thermal ramp segment t₀₇.

While the invention has been described in detail with reference to preferred embodiments thereof, it will be apparent to one skilled in the art that various changes can be made, and equivalents employed, without departing from the scope of the invention. For example, embodiments of the invention may include all of the steps shown in FIG. 5, or may omit one or more of the disclosed steps (e.g., application of an atmospheric profile). Various embodiments of preforms and soldering aids have been disclosed. Within the scope of the invention, combinations of the aforementioned disclosed components other than those combinations explicitly disclosed may be used in a system for solder bonding with a volatile soldering aid.

What is claimed:

1. A system for solder bonding with a volatile soldering aid comprising:
a first component including a first bonding surface;
a second component including a second bonding surface;
solder preform disposed between said first bonding surface and said second bonding surface;
a thermally decomposable solid disposed between said first bonding surface and said second bonding surface;
a chamber enclosing said first component and said second component;
a heat source coupled to said chamber; and
wherein said thermally decomposable solid is convertible entirely to a vapor phase at the melting point of said solder.

2. The system of claim 1, further comprising a gas source coupled to said chamber.

3. The system of claim 1, further comprising a vacuum pump coupled to said chamber.

4. The system of claim 1, wherein said thermally decomposable solid is ammonium chloride.

5. The system of claim 1, wherein said solder preform comprises gold and tin.

6. The system of claim 1, wherein said thermally decomposable solid comprises ammonium chloride.

7. The system of claim 1, wherein said thermally decomposable solid is suspended in a liquid.

8. A volatile soldering aid for improving the flow of a solder, said volatile soldering aid comprising:
a liquid carrier;
a thermally decomposable solid suspended as particles within said liquid carrier; and,
wherein said soldering aid is convertible to a vapor in its entirety at the melting point of said solder.

9. The volatile soldering aid of claim 8, wherein said thermally decomposable solid comprises ammonium chloride.

10. The volatile soldering aid of claim 8, wherein said liquid carrier comprises an aromatic hydrocarbon compound.

11. The volatile soldering aid of claim 8, wherein said liquid carrier comprises an aliphatic hydrocarbon compound.

12. The volatile soldering aid of claim 8, wherein said liquid carrier comprises an alicyclic hydrocarbon compound.

13. The volatile soldering aid of claim 8, wherein said liquid carrier comprises a first liquid with a boiling point less than 100 degrees Celsius and a second liquid with a boiling point greater than 100 degrees Celsius.

14. A method for soldering bonding of a first component to a second component, said method comprising:
inserting a solder preform and a volatile soldering aid in a gap between said first component and said second component to provide a solder assembly;
enclosing said solder assembly in a chamber;
increasing the temperature of said solder assembly to a first temperature at which said soldering aid is converted to a vapor, wherein said first temperature is below the melting point of said solder; and,
further increasing the temperature of said solder assembly to a temperature equal to or greater than the melting point of said solder.

15. The method of claim 14, wherein said volatile soldering aid comprises ammonium chloride.

16. The method of claim 14, wherein said volatile soldering aid comprises a nonpolar liquid.

17. The method of claim 14, wherein said solder preform comprises gold and tin.

18. The method of claim 14, wherein said solder preform comprises a first layer of a first metal and a second layer of a second metal.

19. The method of claim 14, further comprising the application of an atmospheric profile.

20. The method of claim 19, wherein said atmospheric profile comprises the application of a vacuum to said chamber.
